(19) United States
(12) Patent Application Publication
(10) Pub. No.: US 2016/0337610 A1
(43) Pub. Date: Nov. 17, 2016

(54) COMPUTERIZED FURNITURE PIECE AND RELATIVE MULTIMEDIA SYSTEM

(71) Applicant: RE MAGO HOLDING LTD, London (GB)

(72) Inventor: Luca PIZZINATO, Varese (VA) (IT)

(21) Appl. No.: 15/110,437

(22) PCT Filed: Mar. 27, 2014
(86) PCT No.: PCT/IT2014/000083

§ 371 Date: Jul. 8, 2016

(30) Foreign Application Priority Data
Feb. 26, 2014 (IT) MI2014A000289

(51) Int. Cl. H04N 5/655; G06F 1/16; G06F 3/041; A47B 81/06

(52) U.S. Cl. CPC H04N 5/655; A47B 81/06; G06F 1/1605; G06F 3/041; A47B 2220/0091

(57) ABSTRACT

Furniture piece constituted by a container defining a cavity delimited by walls isolating the cavity from the outside environment, includes a multimedia system embedded in at least one of the walls of the container. At least one wall of the furniture piece is movable with respect to the remaining walls of the furniture piece for opening and closing the furniture piece towards the outside environment. These movable walls can be the doors of the furniture piece or those of a household appliance. The inserted multimedia system includes a flat screen monitor connected to a microcomputer, the monitor includes a screen pack including a screen, protective glass sheet and a touchfoil therebetween. The touchfoil is connected to the microcomputer. The screen pack has a thickness ≦5 cm and the size of a normal monitor with size ≧14″. The glass sheet that protects the monitor has a thickness ≧2 cm.

The invention regards the field of computer systems for the house and for the office, which today have become largely irreplaceable for confronting and solving daily life and work problems.

Digital technologies such as the television, radio, computer, tablet, and non-digital media such as the agenda, post-its, small blackboard with chalk pieces for taking notes, wall calendar, mirror, newspapers and magazines, to give some of the most common examples, are objects of great utility even when they are not absolutely necessary. Nevertheless, the assembly of all these objects—particularly in a restricted space such as generally a modern home environment, especially a kitchen—can create problems related to the difficulty of use or aesthetics, giving the impression of a situation of setting disorder, such that often it is necessary to give up some of these objects in order to save only the truly indispensable ones. In addition, all these objects require cleaning, maintenance, possible repairs, reception antennas and electrical power outlets.

With regard to the television, solutions have for some time existed that allow hanging the TV on the wall, like a painting, thus freeing the surface of the supporting furniture piece for other needs. This solution, apart from the advantage of having freed the furniture piece, does not resolve the abovementioned problem because it does not leave substantial freedom of movement for the user, who must always remain, standing or seated, in front of the screen and moreover it does not allow the use of a multiplicity of services beyond that of the television. Naturally, one can think to use the screen of the television as an auxiliary monitor for other apparatuses (such as computers; tablet, smartphones. DVDs, etc.) but this does not resolve the problem: indeed, in addition to having such apparatuses in any case arranged in more or less accessible situations, such apparatuses must be connected to the monitor by means of cables, recreating the situation of disorder that the invention instead remedies.

A multiplicity of services available by means of only one apparatus is offered by a tablet or by a smartphone with its different applications, but also these objects must be at rest generally on a work surface. Such objects are moved from one place to another by the user who later, when they are needed, does not recall where he placed them; in any case, their screens are too small to be of real use, unless one does not have them “under one's nose” during use.

Now, therefore, the Applicant has found that the described drawbacks can be remedied with a new type of multimedia system applicable to a surface such as a masonry wall or the wall of a furniture piece, possibly movable, such as a door of the same, possible embeddable in said wall, capable of providing the user with different services that can be utilized by means of a large-size screen. Objects of the invention are therefore a multimedia system adapted to allow the use of various technological services by means of the use of a large-size screen, said services being activatable by means of the touch of said screen, and a furniture piece of furnishing or service provided with a surface portion connected with said multimedia system.

In a first aspect thereof, the invention therefore regards a furniture piece of furnishing or service, comprising a container that defines a cavity delimited by walls that isolate said cavity from the outside environment, one or more of said walls being movable with respect to the remaining portion of said container in order to allow the opening and closing of said container towards the outside environment, characterized in that it comprises a multimedia system connected with at least one of the walls of said container.

In a second aspect thereof, the invention then regards a multimedia system comprising a monitor connected with a microcomputer characterized in that said monitor comprises a screen pack which includes a screen, a glass sheet for protecting said screen and a device that integrates a touch-screen functionality. In a first embodiment of the invention, said device is a touchfoil inserted between said glass sheet and said screen. In an alternative embodiment of the invention, said device is a screen which inherently integrates therein the touch-screen functionality, whether it is of capacitive or resistive type or activated by means of an infrared ray frame, according to a known technology specifically developed for touch-screen systems.

Further characteristics and advantages of the invention will be clearer from the detailed description of a preferred but not exclusive embodiment of said furniture piece and of said system according to the present invention and, in particular, with reference to the solution that provides for the use of the touchfoil. It will in fact be easy for the man skilled in the art to transfer the teachings provided in the following description to the embodiment of the invention that intends to use a screen with integrated touch-screen functionality.

Such description will now be set forth hereinbelow with reference to a specific embodiment of said objects, provided with the following drawings for merely exemplifying and non-limiting purposes, in which:

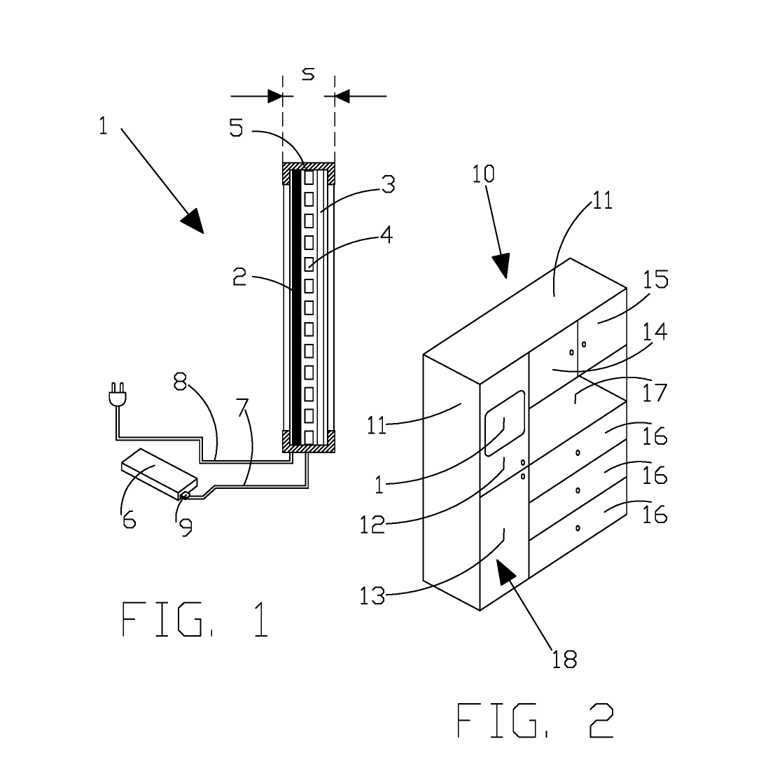

FIG. 1 illustrates the multimedia system according to the invention, in a preferred embodiment;

FIG. 2 illustrates a furniture piece provided with the media system of FIG. 1 in a first embodiment.

With reference to FIG. 1, the multimedia system 1 according to the invention comprises a frame 5 within which the following are arranged: a monitor 2 provided with a screen, a glass sheet 3 for protecting the external surface of said screen and a “touchfoil” 4 inserted between said glass sheet and said screen. The so-called touch screens, i.e. monitor screens (to be intended as any output device on which information visible to the human eye appears) sensitive to the touch (i.e. to the touch of an uncovered part of the human body, generally fingertip, or other equivalent systems) have been known for some time; by means of this touch, they send particular operating directions to the computer connected with the monitor. The device, defined touchfoil hereinbelow in the present description, is preferably a transparent sheet of plastic material, flexible and available in any format (size), which constitutes a matrix of capacitive type governed by a control unit that communicates, to the operating system of the computer connected with said sheet, the coordinates (x,y) of the point touched by the aforesaid fingertip. The aforesaid control unit can be connected to the computer both in serial mode and by means of a USB port. Preferably the touchfoil is inserted between the monitor and the protective glass sheet, creating an air-gap of at least 5 mm between the screen, preferably of LCD type, and the glass on which the touchfoil is applied. This technology allows transferring to the computer the information connected with the point touched by the user on the external surface of the glass sheet. This touchfoil can be applied behind a glass with thickness not greater than 20 mm. This characteristic allows the system of the invention to be able to use transparent glass or mirrors, easily washable and removable, at the same time saving the technology applied beyond the glass.

The touchfoil is connected with a microcomputer 6 which constitutes the core of the multimedia system of the invention and which projects, on the screen of the monitor, the information processed by the software of the programs being executed in the micro-computer.

The multimedia system according to the invention is a very compact device, the monitor is of so-called “flat-screen type”, with a screen preferably of LCD type, or with LED or with Plasma; the so-called “pack” constituted by a screen, touchfoil and glass sheet has a thickness “s” of limited value, preferably not greater than 5 cm, so that it can be easily fit within a frame, such as a panel, or in the wall of a furniture piece. More generically, as furniture piece it is intended a container that defines a cavity delimited by walls which isolate said cavity from the outside environment, where one or more of said walls is movable with respect to the remaining portion of the container in order to allow the opening and closing of said container towards the outside environment. In the present description, by furniture piece it must be intended not only the furniture piece so-called for furnishing (cupboard, library, table, wall unit, dresser, etc.) but also the furniture piece so-called for service, more commonly known as a household appliance, such as a refrigerator, classical oven, microwave oven and dishwasher. Clearly, when the multimedia system must be inserted in a household appliance, the man skilled in the art will have to take the appropriate measures to ensure the operation and protection of the system in relation to the operating characteristics of the household appliance, which provide for high and/or low operating temperatures, moving parts with shaking and/or vibrations of the furniture piece. The multimedia system can also be easily inserted in one of the aforesaid movable walls, normally termed doors, when this type of fitting facilitates the ease of use of said multimedia system.

FIG. 2 illustrates a classic furniture piece 10 for the kitchen: the container that constitutes the assembly of the furniture piece comprises walls 11 which isolate the interior of the furniture piece from the outside environment. The furniture piece 10 comprises a column 18 provided with two doors 12 and 13, a wall portion, it too provided with two doors 14 and 15, and a plurality of drawers 16 arranged below a support surface 17. Clearly, doors and drawers allow being able to introduce objects in the furniture piece and extract the objects contained therein from the same. In accordance with the invention, the multimedia system 1 with the screen directed outward is embedded in the door 12. It is observed that the column 18 is not necessarily the space of a cupboard but can be an embedded refrigerator with the door 12 which closes the normal compartment or the freezer; the aforesaid door 12 can also be that of an oven, in particular a microwave oven, or any other household appliance.

The screen-touchfoil-glass complex (pack) of the multimedia system 1, as stated above, is a very compact device sealed towards the outside environment, impermeable to liquids, and preferably also airtight, from which only the wire 8 possibly exits that brings electrical power to the monitor, together with the wire 7 that brings the digital signal to the touchfoil 4. In order to allow the user to have a good view of the screen, the size of the pack is much larger than that of a tablet or cell phone: preferably the size of the glass 3 corresponds with that of a nearly 10″ screen.

The microcomputer 6 which integrates the multimedia system of the invention comprises a processor, a RAM internal memory, a ROM mass memory according to any available technology, in particular included in the group that comprises Hard disk, Nandflash, MMC, MicroSD, an Operating System, a connectivity card that develops at least one from among the connectivities included in the group that contains wireless, Ethernet. Bluetooth, 3g/LTE, NFC, at least one USB port (9) for connecting with the touch-screen device, and preferably also a webcam, or with any one peripheral device supported by the Operating System, for example a printer, a plurality of programs and a Multi-tasking card for the simultaneous execution of multiple programs.

The aforesaid Operating System, installed in the ROM memory, can be of open source type, such as Google Android™ or Linux™, or not open source, such as Windows™, and in any case an Operating System already arranged for governing interaction peripheral devices such as the touchfoil, the printer or the webcam. Preferably it is an Operating System of so-called embedded type, i.e. operating system typically used in the ROM, lighter with respect to the complete installation of a normal operating system and which has been designed for completing only specific functions.

The Operating System according to the invention allows the interactivity and execution of the programs that allow the video presentation of any digital information referred by the user, for example a phone call, video call, television program, calendar, agenda, electronic post-it, web pages, video games, multimedia files, i.e. anything digital.

The invention solves the stated problems and attains various advantages: when the multimedia system is activated, all the different icons of the programs that the microcomputer provides to the user appear on the screen of the pack. The user, by simply touching the glass at the icon of interest, brings to the video (on the monitor) and activates the relative program, and the user easily follows the course of the program due to the size of the screen which allows him to move inside the room where the multimedia system is installed without losing his view. The system does not require a plurality of accesses to the electrical power supply network since the microcomputer can function directly connected to the network, possibly by means of a suitable transformer, or power supplied by the monitor, or even with batteries, while the monitor can be power supplied by means of a cable connected to the microcomputer or independently (see FIG. 1).

More specifically, the microcomputer is always connected to the monitor, directly or by means of cable (for the exchange of the audio/video signal) while the electrical power supply of the microcomputer can derive directly from the monitor, by means of a connection with USB port, or from the electrical network. Preferably, however, the device for the wireless reception of the TV signal (digital terrestrial and/or satellite) and the transmission of the signal to the micro-computer, is placed far from the microcomputer in a manner so as to prevent the need to wire (e.g. in the furniture piece according to the invention) the antenna cables, since the transmission of said signal can be made with wireless systems.

In the present description, not all the possible structural and size alternatives to the specifically described embodiments were normally illustrated: indeed, it did not seem necessary to expand upon the structural details of the system of the invention since any man skilled in the art, after the instructions given herein, will be able to easily design the most advantageous technical solution, suitably selecting materials and size.

These variants are nevertheless equally intended to be comprised in the protective scope of the present patent, such alternative embodiments being per se easily derivable from the description given herein of the relation that links each embodiment with the result that invention wishes to obtain.

1-12. (canceled)

13. Furniture piece for furnishing and/or for service, comprising a container that defines a cavity delimited by walls which isolate said cavity from the outside environment, one or more of said walls being movable with respect to the remaining portion of said container in order to allow the opening and closing of said container towards the outside environment, and a multimedia system, including a monitor, embedded in at least one of said walls of said container, wherein said monitor is connected with a microcomputer and adapted to allow the use of various technological services by means of the use of a flat type screen of size not less than 10″.

14. The furniture piece according to claim 13, wherein said wall is fixed with respect to the other walls of the furniture piece.

15. The furniture piece according to claim 13, wherein said wall is a door of said furniture piece.

16. The furniture piece according to claim 15, wherein said door is the door of a household appliance.

17. Multimedia system of compact type, embedded in at least one of said walls of said furniture piece, characterized by comprising a microcomputer connected with a monitor adapted to allow the use of various technological services, said monitor including a flat type screen of size not less than 10″.

18. The multimedia system according to claim 17, wherein said monitor comprises a glass sheet for protecting said screen and a device which integrates a touch-screen functionality.

19. The multimedia system according to claim 17, wherein said screen is from group including the LCD type, those with LED and with Plasma.

20. The multimedia system according to claim 18, wherein said device is a touchfoil inserted between said glass sheet and said screen.

21. The multimedia system according to claim 18, wherein said glass sheet has a thickness not greater than 2 cm.

22. The multimedia system according to claim 17, wherein said monitor has a thickness not greater than 5 cm.
